(19) United States
(12) Patent Application Publication
(10) Pub. No.: US 2016/0125819 A1
(43) Pub. Date: May 5, 2016

(54) BISTABLE LIQUID CRYSTAL LIGHT VALVE AND OPERATING METHOD THEREOF

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Guiyu ZHANG, Beijing (CN); Ming HU, Beijing (CN); Taofeng XIE, Beijing (CN)

(21) Appl. No.: 14/564,268

(22) Filed: Dec. 9, 2014

(30) Foreign Application Priority Data
Nov. 3, 2014 (CN) 201410613137.4

(51) Int. Cl. G09G 3/36; G02F 1/139; G02F 1/1343; G02F 1/1337; G02F 1/13; G02F 1/1368

(52) U.S. Cl. CPC G09G 3/3603; G02F 1/132; G02F 1/1368; G02F 1/134309; G02F 1/1337; G02F 1/1391; G02F 2001/134345; G02F 2001/13756

(57) ABSTRACT

A bistable liquid crystal light valve (LCLV) and an operating method thereof are provided. The bistable LCLV comprises: a first transparent substrate and a second transparent substrate oppositely arranged in parallel to each other to form a liquid crystal cell; a first electrode disposed on an inner side of the first transparent substrate; a second electrode being disposed on an inner side of the second transparent substrate and corresponding to the first electrode; and a liquid crystal layer filled into the liquid crystal cell between the first transparent substrate and the second transparent substrate and including nematic liquid crystals and gelators dispersed in the nematic liquid crystals. The liquid crystal layer includes a transparent-state area and a scattering-state area arranged in parallel to each other in the horizontal direction of the first transparent substrate.

### TECHNICAL FIELD

Embodiments of the present disclosure relate to a bistable liquid crystal light valve (LCLV) and an operating method thereof.

### BACKGROUND

Since the 1970s, LCLVs have been gradually widely applied in the aspects of optional information processing, spatial light modulation, large-screen projection display, optical computing and so on. Liquid crystal layers used by the LCLVs possess a reflective state (planar texture (P state)), scattering state (focal conic texture (FC state)) and transparent state (hometropic texture (H state)). People use the three states of the liquid crystals to realize the switching between the light transmission states. For instance, the LCLVs can be applied in welding shields.

At present, LCLVs applied in, for instance, projectors are mainly of a twist nematic (TN) type. The TN type LCLV comprises a liquid crystal cell filled with nematic liquid crystals and two polarization plates respectively disposed on both sides of the liquid crystal cell, and has suitable contrast and resolution. However, as for the double-polarization plate structure adopted by the TN type LCLV, on one hand, the light transmittance of the light valve is reduced, resulting in a projected image of lower brightness; and on the other hand, device heating can be caused by the light absorption of the polarization plates. The conventional TN type is in a normally black mode, adopts an FC state of the liquid crystal layer as an imaging state and an H state of the liquid crystal layer as a transparent state. Thus, the LCLV is in the FC state when not powered on and is in the H state when powered on.

### SUMMARY

At least one embodiment of the present disclosure provides a bistable liquid crystal light valve (LCLV), comprising: a first transparent substrate and a second transparent substrate oppositely arranged in parallel to each other to form a liquid crystal cell; a first electrode disposed on the inner side of the first transparent substrate; a second electrode being disposed on the inner side of the second transparent substrate and corresponding to the first electrode; and a liquid crystal layer filled into the liquid crystal cell between the first transparent substrate and the second transparent substrate and including nematic liquid crystals and gelators dispersed in the nematic liquid crystals. The liquid crystal layer includes a transparent-state area and a scattering-state area arranged in parallel to each other in the horizontal direction of the first transparent substrate.

In one embodiment, for example, the transparent-state area corresponds to an area provided with the first electrode.

In one embodiment, for example, the LCLV further comprises: a first alignment layer disposed on the inner side of the first transparent substrate and covering the first electrode; and a second alignment layer disposed on the inner side of the second transparent substrate and covering the second electrode; the first alignment layer and the second alignment layer have opposite alignment directions.

In one embodiment, for example, the nematic liquid crystals are positive liquid crystals, with the birefringence of Δn>0.200.

In one embodiment, for example, the gelators and the nematic liquid crystals can react with each other for realizing self-assembly.

In one embodiment, for example, the LCLV further comprises a control circuit configured to apply voltage to the first electrode and the second electrode.

In one embodiment, for example, the LCLV further comprises a temperature control unit configured to control the temperature of the liquid crystal layer.

In one embodiment, for example, the second electrode is a plate electrode and is disposed in both the transparent-state area and the scattering-state area.

In one embodiment, for example, the second electrode is a pattern electrode and is only disposed in the transparent-state areas.

In one embodiment, for example, the first electrode includes a plurality of first sub-electrodes.

In one embodiment, for example, the first electrode includes an active drive structure; the active drive structure includes a plurality of sub-pixel units; and each of the plurality of sub-pixel units includes one of the first sub-electrodes and a switching element.

Another embodiment of the present disclosure provides a method for operating any one of the aforesaid bistable LCLVs, comprising: heating the liquid crystal layer of the LCLV to the temperature higher than the clear point of liquid crystals; and applying a voltage between the first electrode and the second electrode of the LCLV, performing cooling, and obtaining a stable transparent-state portions in the transparent-state area of the LCLV and a stable scattering-state portion in the scattering-state area of the LCLV.

In one embodiment, for example, the first electrode includes a plurality of first sub-electrodes; and voltage is applied to part of the plurality of first sub-electrodes.

### BRIEF DESCRIPTION OF THE DRAWINGS

Simple description will be given below to the accompanying drawings of the embodiments to provide a more clear understanding of the technical proposals of the embodiments of the present disclosure. It will be obvious to those skilled in the art that the drawings described below only involve some embodiments of the present disclosure but are not intended to limit the present disclosure.

FIG. 1 illustrates a bistable LCLV provided by one embodiment of the present disclosure.

FIG. 2a is a schematic diagram illustrating the initial state (clear state) of a liquid crystal layer in the LCLV provided by the embodiment of the present disclosure; FIG. 2b is a schematic diagram of a transparent-state area of the liquid crystal layer in the LCLV provided by the embodiment of the present disclosure; FIG. 2c is a schematic diagram of a scattering-state area of the liquid crystal layer in the LCLV provided by the embodiment of the present disclosure.

FIG. 3 is a schematic diagram illustrating the writing and erasing operations of the LCLV provided by the embodiment of the present disclosure.

FIG. 4 illustrates one example of a pattern written into the LCLV provided by an embodiment of the present disclosure.

FIG. 5 is a schematic diagram of a bistable LCLV provided by another embodiment of the present disclosure.

FIG. 6 is a schematic diagram of a bistable LCLV provided by still another embodiment of the present disclosure.

FIG. 7 is a schematic diagram of an electrode drive structure of the bistable LCLV provided by an embodiment of the present disclosure.

### DETAILED DESCRIPTION

For more clear understanding of the objectives, technical proposals and advantages of the embodiments of the present disclosure, clear and complete description will be given below to the technical proposals of the embodiments of the present disclosure with reference to the accompanying drawings of the embodiments of the present disclosure. It will be obvious to those skilled in the art that the preferred embodiments are only partial embodiments of the present disclosure but not all the embodiments. All the other embodiments obtained by those skilled in the art without creative efforts on the basis of the embodiments of the present disclosure illustrated shall fall within the scope of protection of the present disclosure.

Unless otherwise defined, the technical terms or scientific terms used herein have normal meanings understood by those skilled in the art. The words “first”, “second” and the like used in the description and the claims of the patent application of the present disclosure do not indicate the sequence, the number or the importance but are only used for distinguishing different components. Similarly, the words “a”, “an”, “the” and the like also do not indicate the number but only indicate at least one. The word “comprise”, “include” or the like only indicates that an element or a component before the word contains elements or components listed after the word and equivalents thereof, not excluding other elements or components. The words “on”, “beneath”, “left”, “right” and the like only indicate the relative position relationship which is correspondingly changed when the absolute position of a described object is changed.

In the study, the inventors have noted that the TN type LCLV in the normally black mode can only be in one state (FC state or H state) when powered on or not and cannot achieve two-state coexistence in display. Therefore, if a bistable display LCLV is designed, the manufacturing cost can be greatly reduced and the power consumption of the LCLV can be effectively reduced as well.

At least one embodiment of the present disclosure provides a bistable which comprises: a first transparent substrate and a second transparent substrate oppositely arranged in parallel to each other to form a liquid crystal cell; a first electrode disposed on the inner side of the first transparent substrate; a second electrode being disposed on the inner side of the second transparent substrate and corresponding to the first electrode; and a liquid crystal layer filled into the liquid crystal cell between the first transparent substrate and the second transparent substrate and including nematic liquid crystals and gelators dispersed in the nematic liquid crystals. The liquid crystal layer includes at least a transparent-state area and a scattering-state area arranged in parallel to each other in the horizontal direction of the first transparent substrate. For instance, the transparent-state area at least corresponds to an area provided with the first electrode.

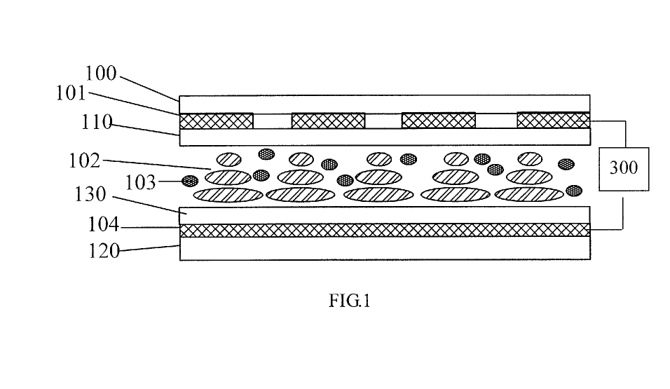

FIG. 1 illustrates a bistable LCLV provided by one embodiment of the present disclosure. The bistable LCLV comprises a first transparent substrate 100 and a second transparent substrate 120. The first transparent substrate 100 and the second transparent substrate 120 are oppositely arranged in parallel to each other to form a liquid crystal cell with sealant (not shown), and a liquid crystal layer is filled in the liquid crystal cell. A first electrode 101 is disposed on the inner side of the first transparent substrate 100 (namely one side facing the liquid crystal layer), and a first alignment layer 110 may cover the first electrode 101 as required. A second electrode 104 is disposed on the inner side of the second transparent substrate 120 (namely one side facing the liquid crystal layer), and a second alignment layer 130 may cover the second electrode 104 as required. The liquid crystal layer filled in the liquid crystal cell includes nematic liquid crystals 102 and gelators 103 dispersed in the nematic liquid crystals 102.

The first transparent substrate 100 and the second transparent substrate 120, for instance, may be a glass substrate, a plastic substrate or the like and may be respectively provided with a structure such as a buffer layer, or a control/drive circuit or the like applied to the first electrode 101 and the second electrode 104.

In the embodiment, the first electrode 101 on the first transparent substrate 100 is a pattern electrode and, for instance, includes a plurality of sub-electrodes arranged in parallel to each other at an interval; and the second electrode 104 on the second transparent substrate 120 is a plate electrode and at least covers an effective display area of the second transparent substrate 120. The first electrode 101 and the second electrode 104 are connected to, for instance, a control circuit 300. Thus, the control circuit 300, for instance, may apply a positive voltage to the first electrode 101 and apply a negative voltage to the second electrode 104 or connect the second electrode 104 to ground, and hence an electric field is formed in an area, in which the first electrode 101 and the second electrode 104 are directly opposite to each other, so as to drive the liquid crystal layer in the area. The plurality of sub-electrodes of the first electrode 101 may be applied with a voltage together and may also be applied with voltage independently. In addition, the first electrode 101 and other circuits (not shown) may also be combined into one part of a resistance heating circuit. The control circuit 300 may apply an electric current to the first electrode 101 so as to perform heating operation.

The first electrode 101 and the second electrode 104, for instance, may be made of a transparent conductive material by means of photolithography. The transparent conductive material is, for instance, indium tin oxide (ITO), indium zinc oxide (IZO), or the like. Or the first electrode 101 and the second electrode 104, for instance, may be a combination comprising a transparent electrode and a metal electrode. Thus, not only the light transmittance but also the resistance is considered.

The first alignment layer 110 and the second alignment layer 130 are, for instance, prepared with polyimide (PI) and have opposite alignment directions to each other to form an anti-parallel alignment structure. In order to form the alignment layer, an aligning agent may be coated on the substrate at first; and a rubbing process is performed after solidification, or photo-curing and alignment process is performed. The alignment layer is helpful to the deflection of liquid crystal molecules of the liquid crystal layer under the action of the electric field. In another embodiment of the present disclosure, the alignment layer may be not formed on at least one of the first transparent substrate 100 and the second transparent substrate 120.

Nematic liquid crystals refer to liquid crystals in nematic phase. The nematic liquid crystals are rod-shaped, can move in the three-dimensional (3D) range, have obvious anisotropy in electricity property, can utilize an external electric field to change the alignment of molecules thereof, and hence the optical performances of the liquid crystals can be changed. For instance, twisted nematic (TN) liquid crystals are twisted in natural state. After an electric current is applied to the liquid crystals, corresponding angle will be twisted reversely according to the applied voltage. In the embodiment of the present disclosure, the applied nematic liquid crystals are, for instance, positive liquid crystals (Δε>0), with the birefringence of Δn>0.200, preferably, Δn>0.220 (e.g., 0.224). Moreover, the nematic liquid crystals preferably have a wide nematic phase temperature range, for instance, are in the nematic phase around the room temperature (e.g., 25° C.). For instance, the nematic liquid crystals include but are not limited to some specific examples as shown below:

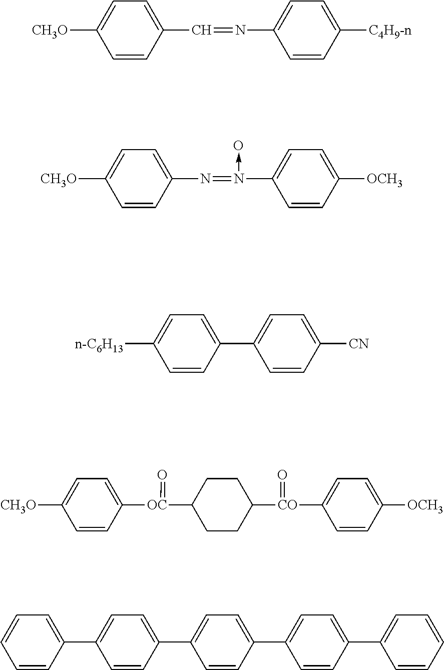

Organogels are usually obtained through polymerization by organic compounds such as hydrocarbons, fatty alcohols or the like. Solid matrix organic gelators are small molecule compounds capable of forming organogels by self-assembly after an appropriate organic solvent is added therein. Currently, the solid matrix organic gelators mainly include fatty acid derivatives, amino acid derivatives, peptide derivatives, saccharide derivatives, organic metal compounds, urea derivatives, amide derivatives, nucleic acid derivatives and the like. For instance, the concentration of the solid matrix organic gelators is about 15%, and the concentration of some supermolecular solid matrix organic gelators can be as low as about 0.1%. The organic gelators are mainly formed by the action of hydrogen bonds, Van der Waals force, π-π action or coordinative metal bonds. Rigid structures of solid matrix organic gelator molecules can form regular bundle structure polymers, and connecting areas between the polymers are like crystallization micro-areas. Thus, the obtained organic gelators have stable properties and cannot be easily dissolved.

Embodiments of the present disclosure can utilize known solid matrix organic gelators. The gelators and the nematic liquid crystals may produce hydrogen-bond action and perform self-assembly operation. For instance, one example of the gelator is as follows:

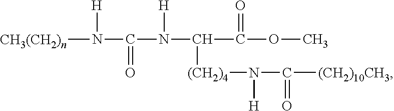

in which n=11-19.

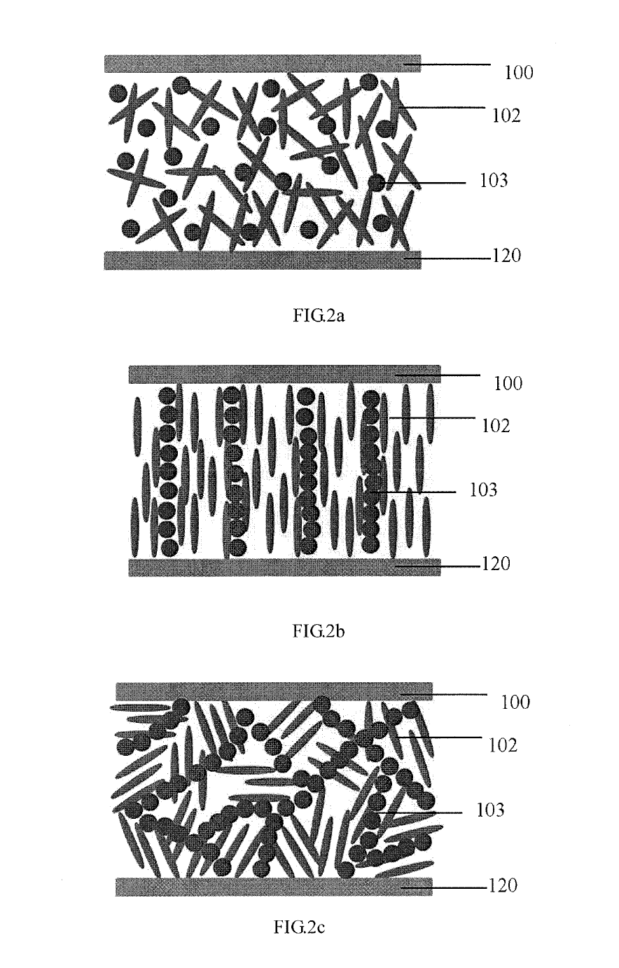

The liquid crystal layer includes transparent-state areas and scattering-state areas arranged side by side in the horizontal direction of the first transparent substrate (namely the horizontal direction of the LCLV). The transparent-state area corresponds to an area provided with the first electrode. The transparent-state area of the liquid crystal layer may be light transmissive and the scattering-state area of the liquid crystal layer may be light-tight, and hence the transparent-state area and the scattering-state area can form a display pattern of the LCLV. In the embodiment as shown in FIG. 1, the transparent-state areas of the liquid crystal layer correspond to the areas provided with the first electrode 101 including a plurality of sub-electrodes, and areas between the sub-electrodes are the scattering-state areas. In the embodiment of the present disclosure, the distribution of the transparent-state areas and the scattering-state areas is not limited to the specific examples as shown in the figures. The microstructure of the transparent-state area and the scattering-state area of the liquid crystal layer of the embodiment of the present disclosure will be described below with reference to FIGS. 2a to 2c.

FIG. 2a is a schematic diagram illustrating the initial state (clear state) of the liquid crystal layer in the LCLV provided by the embodiment of the present disclosure; FIG. 2b is a schematic diagram of a transparent-state area of the liquid crystal layer in the LCLV provided by the embodiment of the present disclosure; and FIG. 2c is a schematic diagram of a scattering-state area of the liquid crystal layer in the LCLV provided by the embodiment of the present disclosure.

As illustrated in FIG. 2a, in the LCLV provided by the embodiment of the present disclosure, the liquid crystal layer disposed between the substrates 100 and 120 is in the initial state, and the transparent-state areas and the scattering-state areas are not divided in the liquid crystal layer as well. At this point, liquid crystal molecules of nematic liquid crystals 102 are randomly aligned, and gelators 103 are basically uniformly dispersed in the liquid crystal molecules of the nematic liquid crystals 102 and are isotropical.

As illustrated in FIG. 2b, in the transparent-state area of the liquid crystal layer disposed between the substrates 100 and 120 in the LCLV provided by the embodiment of the present disclosure, the liquid crystal molecules of the nematic liquid crystals 102 are arranged perpendicular to the upper and lower substrates under the action of an electric field; the gelators 103 are subjected to self-assembly to form a self-assembly structure parallel to the electric field direction, by taking rod-shaped liquid crystal molecules arranged in parallel to the electric field as a template and using the mutual action between hydrogen bonds and the like between the molecules. At this point, incident light can have high transmittance when passing through the LCLV and may be light-transmissive.

As illustrated in FIG. 2c, in the scattering-area area of the liquid crystal layer disposed between the substrates 100 and 120 in the LCLV provided by the embodiment of the present disclosure, the liquid crystal molecules of the nematic liquid crystals 102 are not affected by the electric field but randomly distributed, and the gelators 103 are also subjected to irregular self-assembly due to the mutual action between the hydrogen bonds between the molecules. At this point, the incident light has low transmittance when passing through the LCLV and is almost reflected and scattered. Thus, the light transmission effect can be difficulty obtained on the whole.

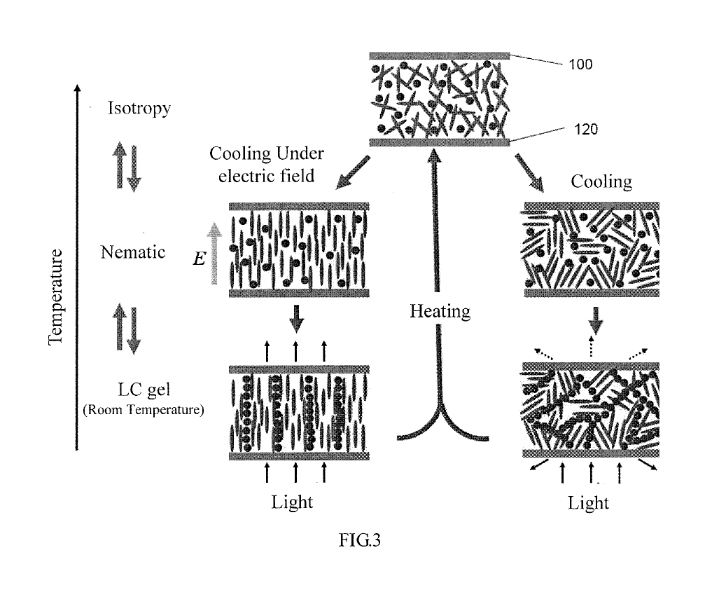

In the embodiment as shown in FIG. 1, the temperature and the electric field of the liquid crystal layer in the LCLV are adjusted by the control circuit 300 to achieve the coexistence of the H state (transparent state) and the FC state (scattering state) of the LCLV, and hence multiple repeated writing and erasing operations of the LCLV can be achieved. Detailed description will be given to the above operation with reference to FIG. 3.

FIG. 3 is a schematic diagram illustrating the erasing operation of the LCLV provided by the embodiment of the present disclosure. The left side of FIG. 3 illustrates the state of the transparent-state area of the liquid crystal layer in the case of cooling, and the right side of FIG. 3 illustrates the state of the scattering-state area in the case of cooling.

In the embodiment, as illustrated in FIG. 3, at first, the control circuit applies an electric current to the first electrode on the first transparent substrate 100 so as to adjust the temperature of the LCLV. As the temperature of the liquid crystal layer is raised due to the heating of the first electrode, the liquid crystal layer is at the temperature higher than the clear point thereof. At this point, the liquid crystal molecules of the nematic liquid crystals of the liquid crystal layer are randomly distributed, and the gelators are basically uniformly dispersed in the liquid crystal molecules of the nematic liquid crystals and are isotropical (corresponding to FIG. 2a).

Subsequently, the control circuit stops applying the electric current to the first electrode and applies a voltage between the first electrode and the second electrode, and hence a vertical electric field perpendicular to the substrate is established in an area in which the first electrode and the second electrode are directly opposite to each other. Meanwhile, no vertical electric field is formed in an area in which the first electrode and the second electrode are not directly opposite to each other. Subsequently, the liquid crystal layer of the LCLV is cooled under the condition of maintaining the applied voltage.

As shown by the left side of FIG. 3, in an area provided with the vertical electric field in the LCLV, the nematic liquid crystals in the nematic phase of the liquid crystal layer are affected by the vertical electric field, and the rod-shaped liquid crystal molecules are arranged in parallel to the electric field; along with the decrease of the temperature of the LCLV, at the gel point, the gelators are subjected to self-assembly to form a self-assembly structure parallel to the electric field direction, by taking the rod-shaped liquid crystal molecules arranged in parallel to the electric field as a template and using the mutual action of hydrogen bonds and the like between the molecules, and finally stable liquid crystal gel is obtained. The liquid crystal gel is in the transparent state and has high light transmittance, and the incident light can pass through the area provided with the transparent-state liquid crystals. Thus, the transparent-state area of the liquid crystal layer of the LCLV is obtained (corresponding to FIG. 2b).

Meanwhile, as shown by the right side of FIG. 3, in an area, not provided with the vertical electric field, of the LCLV, the nematic liquid crystals in the nematic phase of the liquid crystal layer are not affected by the vertical electric field, and the rod-shaped liquid crystal molecules are still randomly arranged; along with the decrease of the temperature of the LCLV, at the gel point, the gelators are subjected to irregular self-assembly due to the mutual action of hydrogen bonds and the like between molecules; and finally stable liquid crystal gel is obtained. The liquid crystal gel is in the scattering state and has low light transmittance, and the incident light is reflected or scattered and deviated from the incident direction and hence is hard to pass through the area provided with the scattering-state liquid crystals. Thus, the scattering-state area of the liquid crystal layer of the LCLV is obtained (corresponding to FIG. 2c).

The transparent-state areas and the scattering-state areas of the liquid crystal layer can be visually distinguished and hence can be used for displaying specific pattern.

By adoption of the above operation, the obtained LCLV in the stable state achieves display by means of the coexistence of the transparent state (H state) and the scattering state (FC state). Similarly, the above operation may also be performed again, as shown by an arrowhead marked by “Heating” in FIG. 3, that is to say, the formed pattern is erased by adoption of the control circuit to adjust the temperature of the LCLV, and subsequently a new pattern is rewritten by the above operation. Thus, multiple repeated erasing and writing operations of the LCLV can be realized.

In the writing operation, a voltage may be applied between the second electrode 104 and the entire first electrode 101 and may be also applied between the second electrode 104 and partial first electrode 101. In this case, different transparent patterns can be obtained by different erasing operations, and hence the scattering-state areas and the transparent-state areas in different distribution patterns can be also obtained.

FIG. 4 illustrates an example of a pattern written into the LCLV provided by an embodiment of the present disclosure. As shown in the figure, the LCLV comprises a first transparent substrate 201 and a second transparent substrate 202 arranged from the top down; the space between the first transparent substrate 201 and the second transparent substrate 202 is sealed by sealant; an area 203 belongs to a scattering-state area and is light-tight, and three alphabets BOE are respectively formed; an area 204 also belongs to a scattering-state area and is light-tight, and two vertical lines disposed on both sides of the alphabets BOE are formed; and an area 205 is a transparent-state area and is light-admitting. The areas 203 to 205 are combined to form an effective display area, and a peripheral non-display area is, for instance, provided with black matrixes in defining the areas. Therefore, when the LCLV is powered on and cooled to the gel state, the LCLV can achieve the coexistence display of the scattering state and the transparent state and can achieve multiple repeated erasing and writing operations. The embodiment of the present disclosure is not limited to specific pattern.

FIG. 5 is a schematic diagram of a bistable LCLV provided by another embodiment of the present disclosure. The difference between the bistable LCLV provided by the embodiment and the embodiment as shown in FIG. 1 is that: the bistable LCLV further comprises a temperature control unit 400 which is, for instance, disposed on one side of a display panel and configured to control the temperature of the display panel, e.g., heating or cooling, so as to convert the liquid crystal layer of the LCLV to be the initial state (clear state). The temperature control unit 400, for instance, may be a resistance heating unit, an infrared heating unit or the like.

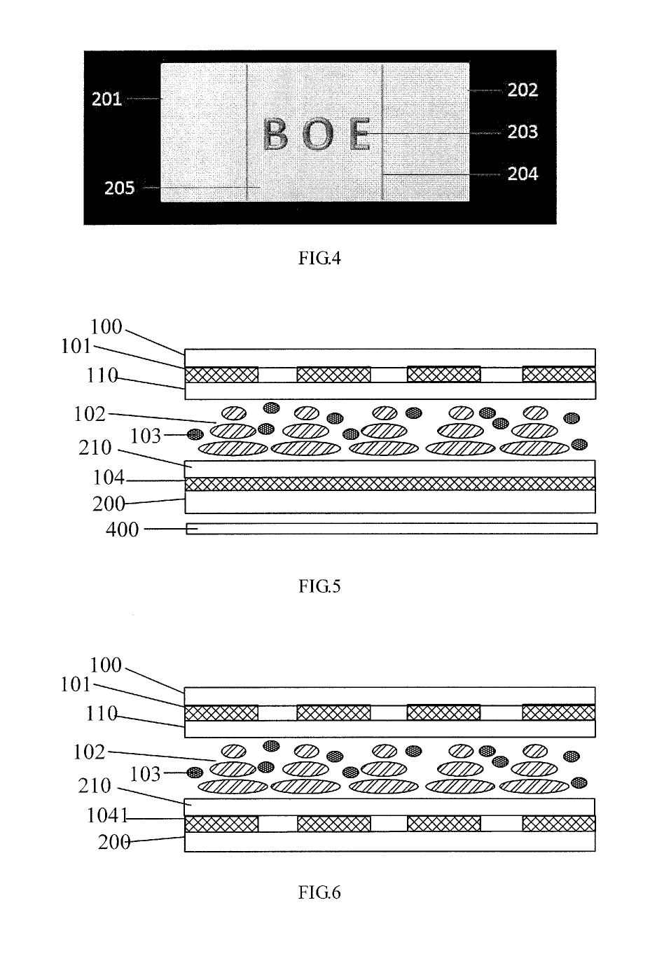

FIG. 6 is a schematic diagram of a bistable LCLV provided by still another embodiment of the present disclosure. The difference between the bistable LCLV provided by the embodiment and the embodiment as shown in FIG. 1 is that: the second electrode 104 disposed on the second transparent substrate 120 is also a pattern electrode, e.g., including a plurality of sub-electrodes 1041 arranged in parallel to each other at an interval, and is not a plate electrode any more. At this point, the plurality of sub-electrodes of the first electrode 101 and the plurality of sub-electrodes of the second electrode 104, disposed on the upper side and the lower side of the liquid crystal layer, correspond to each other in the vertical direction. Thus, the second electrode 104 also corresponds to the transparent-state areas of the liquid crystal layer. Moreover, the second electrode 104 and other circuits (not shown) may also be combined to form one part of a resistance heating circuit, and the control circuit 300 may apply an electric current to the second electrode 104 so as to perform a heating operation. The first electrode 101 and the second electrode 104 can be more quickly and more uniformly heated by being subjected to heating at the same time.

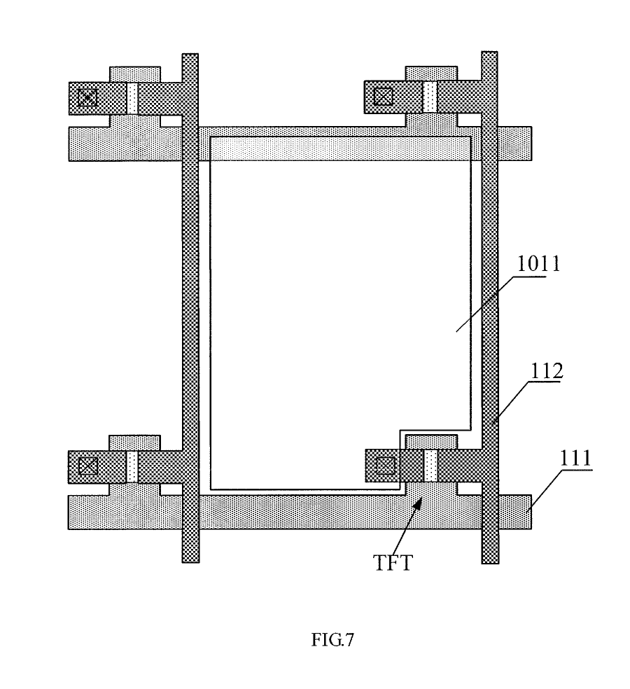

FIG. 7 is a schematic diagram of an electrode drive structure of the bistable LCLV provided by an embodiment of the present disclosure. The electrode drive structure is, for instance, configured to replace the first electrode on the first transparent substrate in the embodiment as shown in FIG. 1. The electrode drive structure is of an active drive type, in which a thin-film transistor (TFT) is used as a switching element, and usually cannot be used for heating. The active drive structure includes a plurality of gate lines 111 and a plurality of source lines 112. The gate lines 111 and the source lines 112 are intercrossed to define sub-pixel units arranged in a matrix. Each sub-pixel unit includes a TFT taken as a switching element and a first sub-electrode (pixel electrode) 1011 configured to apply voltage. For instance, as for the TFT of each pixel, a gate electrode is electrically connected or integrally formed with corresponding gate lines 111; a source electrode is electrically connected or integrally formed with corresponding source lines 112; and a drain electrode is electrically connected or integrally formed with corresponding pixel electrode 1011. A gate-on signal can be applied to the gate lines 111 so as to switch on or off the TFT. Drive voltages can be applied to the source lines 112. The drive voltage is, for instance, at a fixed value. The active drive structure, for instance, may be manufactured by a process for manufacturing an array substrate of a thin-film transistor liquid crystal display (TFT-LCD). Thus, the active drive structure may be operated by corresponding drive circuit, so as to obtain an expected pattern.

The following description mainly aims at a single pixel unit, but other pixel units may be formed and operated by the same means.

With the electrode drive structure, the transparent-state areas and the scattering-state areas may be disposed in the LCLV as required, and hence varied patterns can be obtained. When a voltage is required to be applied to the first sub-electrode 1011 in specific pixel unit so as to obtain a transparent state in the corresponding area thereof, a gate-on voltage (signal) is applied to the corresponding gate line to switch on the TFT of the display unit, and a drive voltage is applied to the corresponding source line. The drive voltage charges the first sub-electrode 1011 through the TFT, and hence the arrangement of the liquid crystal molecules in the liquid crystal layer can be controlled by the cooperation of the second electrode 104 on the second transparent substrate (or corresponding sub-electrodes of the second electrode 104).

Another embodiment of the present disclosure further provides a method for operating the bistable LCLV, which comprises: heating the liquid crystal layer of the LCLV to the temperature higher than the clear point of liquid crystals; and applying a voltage between the first electrode and the second electrode of the LCLV, performing cooling, and obtaining stable transparent-state portions in the transparent-state areas of the LCLV and stable scattering-state portions in the scattering-state areas of the LCLV. The description actually has been given to the operating method with reference to FIGS. 2a to 2c, and therefore no further description will be given here.

In the bistable LCLV and the operating method thereof, provided by the embodiments of the present disclosure, compared with the traditional TN type LCLV, firstly, the gelators are introduced into the nematic liquid crystals in the LCLV, so that the bistable display of the LCLV can be achieved, and accordingly the application range becomes wider. Secondly, multiple repeated erasing and writing operations of the display content of the LCLV can be achieved by the adjustment of the temperature of the LCLV, and hence the power consumption of the LCLV can be effectively reduced. Thirdly, as multiple repeated erasing and writing operations of the display content of the LCLV is achieved by the adjustment of the temperature of the LCLV, the operations are simple and visible. Fourthly, as the polarization plates disposed on both sides of the liquid crystal cell are not required like the traditional TN type LCLV, the LCLV has simpler structure, simpler manufacturing process correspondingly and lower manufacturing cost.

Moreover, it should be noted that the structures of the embodiments of the present disclosure, described above, may be combined with each other and replaced to obtain a new embodiment. For instance, the embodiment as shown in FIG. 6 may further comprise a temperature control unit; and one of the first electrode and the second electrode in the embodiment as shown in FIG. 6 may adopt the active drive mode as shown in FIG. 7.

The foregoing is only the preferred embodiments of the present disclosure and not intended to limit the scope of protection of the present disclosure. The scope of protection of the present disclosure should be defined by the appended claims.

1. A bistable liquid crystal light valve (LCLV), comprising:
a first transparent substrate and a second transparent substrate oppositely arranged in parallel to each other to form a liquid crystal cell;
a first electrode disposed on an inner side of the first transparent substrate;
a second electrode being disposed on an inner side of the second transparent substrate and corresponding to the first electrode; and
a liquid crystal layer filled into the liquid crystal cell between the first transparent substrate and the second transparent substrate and including nematic liquid crystals and gelators dispersed in the nematic liquid crystals,
wherein the liquid crystal layer includes a transparent-state area and a scattering-state area arranged in parallel to each other in a horizontal direction of the first transparent substrate.

2. The bistable LCLV according to claim 1, wherein the transparent-state area corresponds to an area provided with the first electrode.

3. The bistable LCLV according to claim 1, further comprising:
a first alignment layer disposed on the inner side of the first transparent substrate and covering the first electrode; and
a second alignment layer disposed on the inner side of the second transparent substrate and covering the second electrode,
wherein the first alignment layer and the second alignment layer have opposite alignment directions.

4. The bistable LCLV according to claim 1, wherein the nematic liquid crystals are positive liquid crystals, with the birefringence of Δn>0.200.

5. The bistable LCLV according to claim 1, wherein the nematic liquid crystal includes any one or any combination of following liquid crystals:

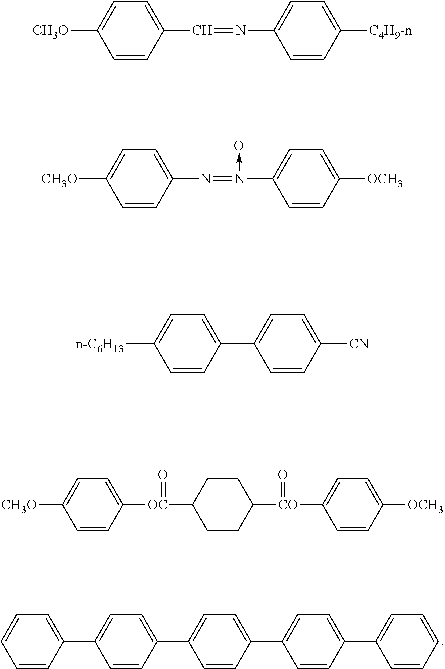

6. The bistable LCLV according to claim 1, wherein the gelators and the nematic liquid crystals are able react with each other for realizing self-assembly.

7. The bistable LCLV according to claim 6, wherein the gelator includes: 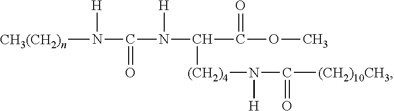
wherein n=11-19.

8. The bistable LCLV according to claim 1, further comprising a control circuit configured to apply voltage to the first electrode and the second electrode.

9. The bistable LCLV according to claim 1, further comprising a temperature control unit configured to control the temperature of the liquid crystal layer.

10. The bistable LCLV according to claim 1, wherein the second electrode is a plate electrode and is disposed in both the transparent-state area and the scattering-state area.

11. The bistable LCLV according to claim 1, wherein the second electrode is a pattern electrode and is only disposed in the transparent-state area.

12. The bistable LCLV according to claim 11, wherein the second electrode includes a plurality of second sub-electrodes.

13. The bistable LCLV according to claim 1, wherein the first electrode includes a plurality of first sub-electrodes.

14. The bistable LCLV according to claim 13, wherein the first electrode includes an active drive structure; the active drive structure includes a plurality of sub-pixel units; and
each of the plurality of sub-pixel units includes one of the first sub-electrodes and a switching element.

15. The bistable LCLV according to claim 2, further comprising:
a first alignment layer disposed on the inner side of the first transparent substrate and covering the first electrode; and
a second alignment layer disposed on the inner side of the second transparent substrate and covering the second electrode,
wherein the first alignment layer and the second alignment layer have opposite alignment directions.

16. The bistable LCLV according to claim 13, wherein the second electrode is a plate electrode and is disposed in both the transparent-state area and the scattering-state area.

17. The bistable LCLV according to claim 13, wherein the second electrode is a pattern electrode and is only disposed in the transparent-state area.

18. The bistable LCLV according to claim 17, wherein the second electrode includes a plurality of second sub-electrodes.

19. A method for operating the bistable LCLV according to claim 1, comprising:
heating the liquid crystal layer of the LCLV to the temperature higher than a clear point of liquid crystals; and
applying a voltage between the first electrode and the second electrode of the LCLV, performing cooling, and obtaining a stable transparent-state portion in the transparent-state area of the LCLV and a stable scattering-state portion in the scattering-state area of the LCLV.

20. The operating method according to claim 14, wherein the first electrode includes a plurality of first sub-electrodes; and the voltage is applied to part of the plurality of first sub-electrodes.
